(19) United States
(12) Patent Application Publication
(10) Pub. No.: US 2011/0064129 A1
(43) Pub. Date: Mar. 17, 2011

(54) VIDEO CAPTURE AND GENERATION AT VARIABLE FRAME RATES

(75) Inventors: James D. Bennett, Hroznetin (CZ); Jeyhan Karaoguz, Irvine, CA (US)

(73) Assignee: BROADCOM CORPORATION, Irvine, CA (US)

(21) Appl. No.: 12/644,260

(22) Filed: Dec. 22, 2009

Related U.S. Application Data
(60) Provisional application No. 61/242,973, filed on Sep. 16, 2009.

(51) Int. Cl. H04N 7/12

(52) U.S. Cl. 375/240.01; 375/E07.076

(57) ABSTRACT

A variable frame rate capture system and video encoder captures sequences of video frames at multiple frame rates depending upon the differences between the prior neighboring frames, and a video encoder encodes and time stamps the video frames to produce variable frame rate video stream. Another device receives sequences of video frames and a variable frame rate video encoder groups them, selectively discards some video frames of sequential groups depending upon the differences between the prior neighboring frames, and encodes and time stamps the video frames to produce variable frame rate video stream. Another device includes a variable rate video encoder that encodes and time stamps the video frames to produce variable frame rate video stream.

### CROSS-REFERENCE TO PRIORITY APPLICATION

The present application claims priority to U.S. Provisional Application No. 61/242,973, filed Sep. 16, 2009, which is incorporated herein in its entirety for all purposes.

### BACKGROUND

1. Technical Field

The present invention relates generally to video capturing devices; and, more particularly, video capture and generation at variable frame rates.

2. Related Art

Just a decade ago, digital video capturing devices such as digital video cameras and computers with attached digital video cameras were fairly uncommon. Video games with digital video contents were very basic in nature. Devices that were commercially available had very limited video resolution and generally produced extremely poor quality video. These devices did, however, have limited memory storage requirements. Today, digital video and gaming devices are capable of producing high quality video. High quality video capture, storage, and play however have necessitated large memory storage and data transfer requirements.

Video capturing systems employed in current digital video and gaming devices not only necessitate a large memory for storage but cause blurred moving images of fast moving scenes. For instance, a moving image at a standard frame rate results in blurred the moving images, e.g., when the subjects or backgrounds are moving at a very fast pace. Nonetheless, in all of these digital video and gaming devices growth, along with other necessary hardware growth, the demand for better quality moving images with smaller memory requirements has increased. Many compression techniques that save memory are available as of today; even though they are not helpful in eliminating some of the abovementioned problems either.

For instance, conventional systems typically sample (capture) video at a constant 24-30 frames a second, and each of those frames are often encoded using a standard such as MPEG, DIVX, AVI, etc. Such samples are at fixed frame rate spacing, e.g., 1/24 seconds, between adjacent frames. At times, because the subject being captured (typically real life objects) move slowly, such sampling rates are more than sufficient to satisfy a viewing eye. When the subjects move very fast, such sampling rates may be perceived as blurred upon display. Increasing the sampling rate correspondingly increases the amount of data. Thus, a standard frame rate is chosen to accept tolerable blurring of infrequent high speed motion, while providing excessively sufficient in-focus video for slower or stationary motion. This is also the situation for graphics generation from, for example, video games.

These and other limitations and deficiencies associated with the related art may be more fully appreciated by those skilled in the art after comparing such related art with various aspects of the present invention as set forth herein with reference to the figures.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a system diagram illustrating a plurality of devices constructed and operating according to one or more embodiments of the present invention for producing variable frame rate video output;

FIG. 2 is a block diagram illustrating a device constructed and operating according to one or more one or more embodiments of the present invention for producing variable frame rate video output;

FIG. 3A is a block diagram illustrating components of a device constructed and operating according to one or more embodiments of the present invention for producing variable frame rate video output by altering capture/generation video frame rate;

FIG. 3B is a block diagram illustrating components of a device constructed and operating according to one or more embodiments of the present invention for producing variable frame rate video output by parsing video frames of a fixed frame rate input;

FIG. 4 is a flow diagram illustrating functionality of a variable frame rate video generation device according to one or more embodiments of the present invention;

FIG. 5 is a flow diagram illustrating functionality of a variable frame rate video generation device according to one or more embodiments of the present invention;

FIG. 6 is a flow diagram illustrating functionality of a variable frame rate video generation device according to one or more embodiments of the present invention;

FIG. 7 is a flow diagram illustrating functionality of a variable frame rate video generation device according to one or more embodiments of the present invention; and

FIG. 8 is a flow diagram illustrating functionality of a variable frame rate video generation device according to one or more embodiments of the present invention.

### DETAILED DESCRIPTION OF THE DRAWINGS

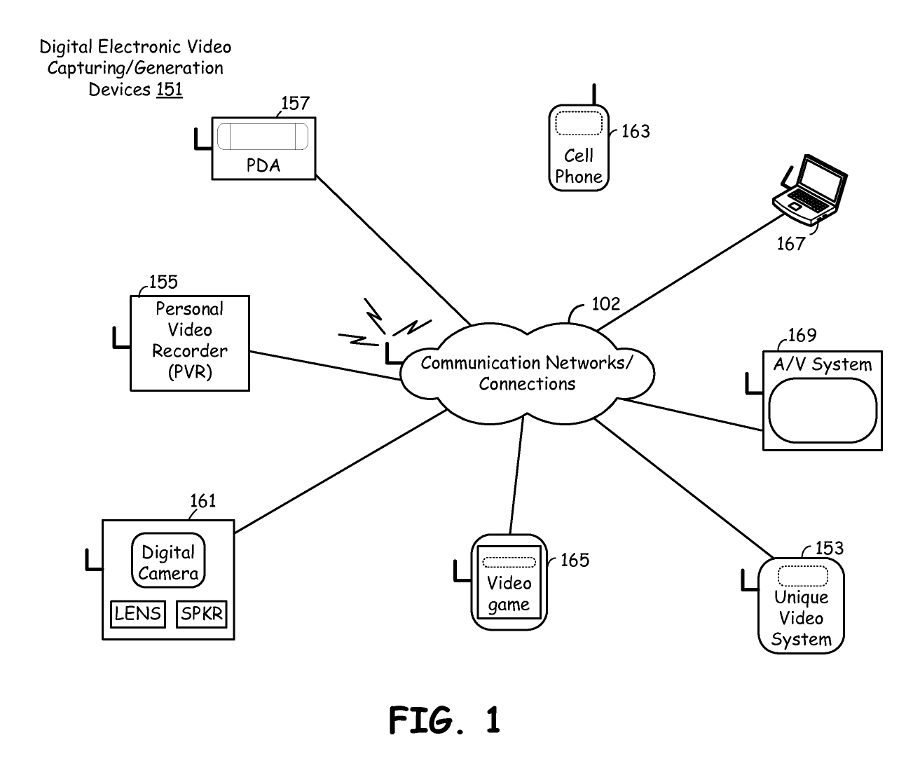

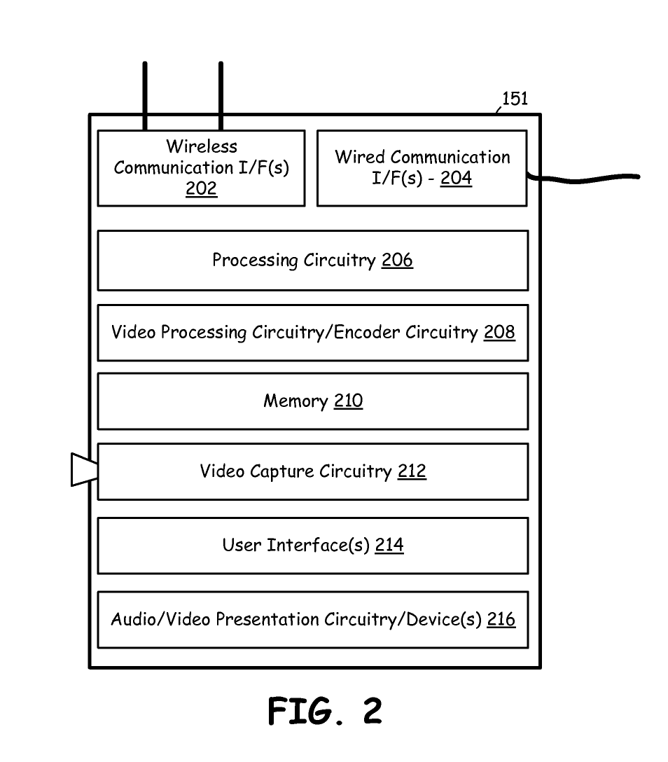

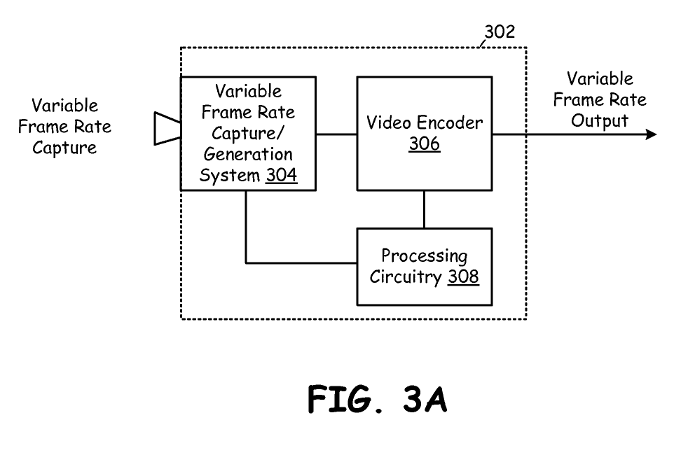

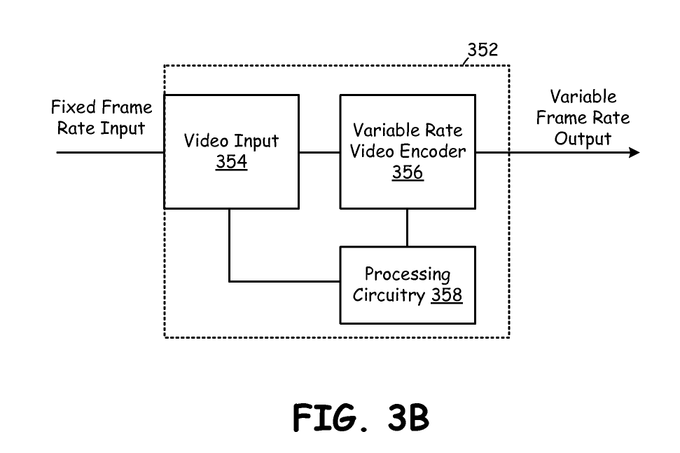

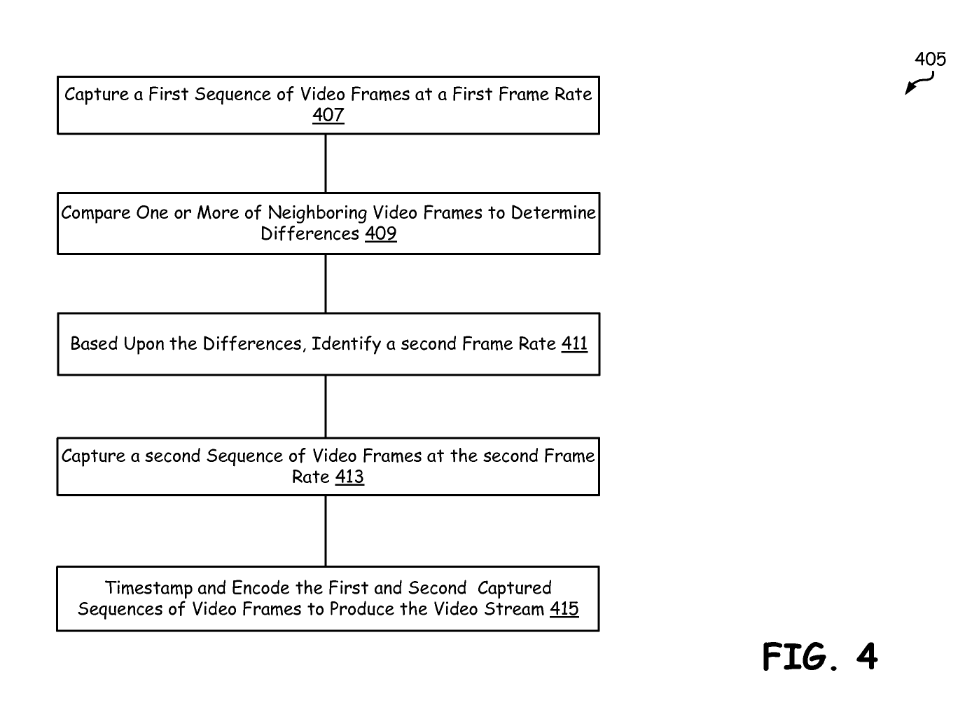

FIG. 1 is a system diagram illustrating a plurality of devices constructed and operating according to one or more embodiments of the present invention for producing variable frame rate video output. Illustrated in FIG. 1 is a plurality of digital electronic video capturing/generation devices 151. These devices 151 may include a unique video system 153, a Personal Video Recorder (PVR) 155, a Personal Data Assistant (PDA) 157, a digital camera 161, a cell phone 163, a video game 165, a laptop computer 167, and an audio/visual system 169. These devices include structure and perform operations according to one or more aspects of the present invention. These devices support communication via one or more communication networks 102 with each other and with remote devices that are not illustrated in FIG. 1. A generic structure of these devices is illustrated in FIG. 2. Particular structures of one or more of these devices are illustrated in FIGS. 3A and 3B. Operations performed by these devices are illustrated in FIGS. 4-8.

Generally, one or more of these devices 151 is operable to produce a variable frame rate video output. The variable frame rate video output may be transmitted to another device via the communication networks 102, stored locally, or displayed locally. Each of these devices 151 includes structure and performs operations to support communications. Some of these devices 151 are operable to capture video, e.g., video cameras or devices that include video cameras, some are operable to produce video based upon input received, e.g., video game 165, and some are operable to process received/stored video. Each of these devices is operable to produce variable frame rate video output.

The manner in which the variable frame rate video output is produced differs from embodiment to embodiment. Generally, the frame rate may change over time and is based upon the content of video information captured/stored/displayed. By varying frame rate over time that is based upon the content over time, communication load and/or storage load is reduced. With some embodiments, the frame rate at which the video is captured varies over time based upon the video content. With other embodiments, video is captured, generated, or received at a fixed frame rate, the video is analyzed, and frames are discarded so that the frame rate of video output is varied. As the reader appreciates, output video may be encoded or unencoded, depending upon the embodiment.

Generally, with a first embodiment, a device 151 of FIG. 1 generates an encoded video data stream and includes at least a variable frame rate capture system and a video encoder. The variable frame rate capture system captures a first sequence of video frames at a first frame rate. The variable frame rate capture system compares at least two neighboring frames of the first sequence of video frames to determine differences between the at least two neighboring frames. The variable frame rate capture system captures a second sequence of video frames at the first frame rate when a first comparison result is met. The variable frame rate capture system then captures a second sequence of video frames at a second frame rate that differs from the first frame rate when a second comparison result is met. Finally, the video encoder encodes the first sequence of video frames and the second sequence of video frames to produce the encoded video stream and time stamps video frames of the first set of successive video frames and the second set of successive video frames.

With some operations, the first sequence of video frames may include time stamps and the time stamps flow through encoding process. With other operations, the variable frame rate capture system captures a third sequence of video frames at a third frame rate that differs from both the first frame rate and the second frame rate when a third comparison result is met. With these other operations, the video encoder encodes the first sequence of video frames, the second sequence of video frames, and the third sequence of video frames to produce the encoded video stream.

With some of the devices 151, the capturing may be performed by digital camera. With other of the devices, the variable frame rate capture system is a portion of an electronic video game and comparing at least two neighboring frames of the first sequence of video frames to determine difference between the at least two neighboring frames is based upon graphical element content of the at least two neighboring frames.

With other embodiments of the devices 151 of FIG. 1, the device includes a video input that receives a sequence of video frames at a first frame rate. A variable frame rate video encoder couples to the video input and the variable frame rate video encoder receives the sequence of video frames at the first frame rate from the video input. The variable frame rate video encoder compares at least two neighboring frames of the sequence of video frames to determine differences between the at least two neighboring frames. The variable frame rate video encoder partitions the sequence of video frames into a first sequential group of video frames and a second sequential group of video frames. Further, the variable frame rate video encoder selectively discards some video frames of the first sequential group of video frames such that the first sequential group of video frames has a second frame rate that is less than the first frame rate. Moreover, the variable frame rate video encoder encodes the first sequential group of video frames and the second sequential group of video frames to produce the video stream and time stamps the video frames of the video stream.

In some operations, the first sequential group of video frames has less relative inter-frame motion than does the second sequential group of video frames. With other operations, the variable frame rate video encoder partitions the second sequential group of video frames into a third sequential group of video frames and a fourth sequential group of video frames and the variable frame rate video encoder selectively discards some video frames of the third sequential group of video frames and the fourth sequential group of video frames such that the third sequential group of video frames and the fourth sequential group of video frames have differing frame rates.

In yet another embodiment of a device 151 of FIG. 1, the device includes a variable frame rate capture system and a video encoder. The variable frame rate capture system captures a first sequence of video frames at a first frame rate and the variable frame rate capture system compares at least two neighboring frames of the first sequence of video frames to determine difference between the at least two neighboring frames. The variable frame rate capture system then captures a second sequence of video frames at a second frame rate that is greater than the first frame rate. The variable frame rate capture system further captures a third sequence of video frames at a third frame rate that is less than the first frame rate. Finally, the video encoder encodes the first sequence of video frames, the second sequence of video frames, and the third sequence of video frames to produce the encoded video stream. The video encoder time stamps video frames of the first, second, and third sequence of video frames. Alternately, the variable frame rate capture system time stamps time stamps the video frames of the first, second, and third sequence of video frames.

In its operations, the variable frame rate capture system may step a capture rate from the first capture rate to the second capture rate. Alternately, the variable frame rate capture system steps a capture rate from the first capture rate to the third capture rate. In some embodiments, the variable frame rate capture system is a digital camera. Alternately, the variable frame rate capture system is a portion of an electronic video game and the variable frame rate capture system comparing at least two neighboring frames of the first sequence of video frames to determine difference between the at least two neighboring frames is based upon graphical element content of the at least two neighboring frames.

FIG. 2 is a block diagram illustrating a device constructed and operating according to one or more one or more embodiments of the present invention for producing variable frame rate video output. The device 151 includes one or more wireless interfaces 202, one or more wired communication interfaces 204, processing circuitry 206, video processing circuitry/encoder circuitry 208, and memory. The device 151 also may include video capture circuitry 212, one or more user interfaces 214, and may include audio/video presentation circuitry device(s) 216. The wireless communication interfaces 204 may support cellular communications, Wireless Wire Area Network (WWAN) communications, e.g., WiMAX, Wireless Local Area Network (WLAN) communications, e.g., IEEE 802.11x communications, Wireless Personal Area Network (WPAN) communications, e.g., Bluetooth, infrared communications, millimeter wave communications, e.g., 60 GHz communications, satellite communications, and/or other wireless communications. The wired communication interface(s) 204 may support serial communications, e.g., USB, Fire wire, or parallel communications. The processing circuitry may include one or more system processors, digital signal processors, fixed processing circuitry, configurable processing circuitry, application specific processing circuitry, or other circuitry that is operable to process data and/or execute software instructions. The memory 210 may include one or more of RAM, ROM, magnetic storage, optical storage, flash memory, or another type of memory capable of storing data and software instructions.

The video processing circuitry/encoder circuitry 208 operates upon video frames to characterize and/or encode the video frames, according to an MPEG standard, a JPEG standard, or another video processing technique. The reader should appreciate that the operations of the present invention regarding video frames may be performed by the processing circuitry 206, the video processing circuitry/encoder circuitry 208, or a combination of these. In some constructs, the device 151 may not have dedicated video processing circuitry or encoder circuitry and a system processor or digital signal processor may perform all operations on the video frames.

The video capture circuitry 212 is operable to capture video frames. The video capture circuitry 212 may include a camera or may couple to an external camera. According to some embodiments of the present invention, the video capture circuitry 212 is operable to capture/receive video data a fixed frame rate. According to other embodiments of the present invention, the video capture circuitry 212 is operable to capture/receive vide data at variable frame rates. Such operations will be described further herein in detail.

The device 151 further includes one or more user interfaces such as a keypad, pointing device, cursor device, screen, speakers, microphone, or other user interface devices. The device 151 may also include audio/video presentation circuitry, interface(s), or devices 216. These components 216 assist or actually present audio/video data to a user. In some embodiments, these components 216 produce output for presentation by one or more other components, such as external speakers, an external video display, and/or other components.

FIG. 3A is a block diagram illustrating components of a device constructed and operating according to one or more embodiments of the present invention for producing variable frame rate video output by altering capture/generation video frame rate. The device 302 has components that may be included with one of the devices 151 of FIGS. 1 and 2. Generally, the device 302 includes a variable frame rate capture system 304, a video encoder 306, and processing circuitry 308 that communicatively couple to each other to implement one or more operations of the present invention.

The variable frame rate capture system 304 captures sequences of video frames at multiple frame rates depending upon the differences between the prior neighboring frames, and video encoder 306 encodes and time stamps the video frames to produce variable frame rate video stream. In other words, variable frame rate video generation device 302, when working independently (as a standalone video capturing device) or incorporated into digital electronic video capturing systems (and electronic video games), generates a variable frame rate video stream that not only enhances the viewing video quality but also minimizes the storage size of the visual media content hence generated.

Typically, the first stage of digital electronic video capturing systems 157, 161, 163, 167, 155 and 153 consists of video capturing modules that sample the captured video content at a fixed sampling or frame rate. However, according to the present invention, the variable frame rate video generation device 302 captures video frames sampled at variable (stepwise) rates to produce a variable frame rate video stream. To produce the variable frame rate video stream (that enhances the viewing video quality and minimizes storage requirements), the variable frame rate capture system 304, to begin with, samples a first sequence of video frames at a standard prefixed (first) sampling rate. For instance, a standard prefixed (first) sampling rate of the variable frame rate capture system 304 may also be anywhere between 24 to 30 video frames per second. Moreover, in the abovementioned instance, the first sequence of video frames may contain ten video frames (or more, if the processing time required to determine the next sampling rate, as described in the following paragraphs, is more), sampled at the abovementioned standard prefixed (first) sampling rate.

Then, the variable frame rate capture system 302 (the processing circuitry 308, in conjunction with the video encoder 306) determines a quantitative difference between the neighboring video frames, by comparing at least two neighboring video frames of the first sequence of video frames. In the abovementioned instance, the variable frame rate capture system 302 may compare second and third video frames and then eighth and ninth video frames to determine an approximate average variation from the second to third frame and then eighth to ninth frame. Alternatively, the variable frame rate capture system 302 may compare each of the video frames with the first video frame.

Once an average difference is numerically (quantitatively) determined, the variable frame rate capture system 302 determines a new video frame rate for a second sequence of video frames. This is done by using a look up table that provides stepwise video frame rates that are dependent upon the numerical difference. For instance, the stepwise video frame rates may vary between 15 to 30 video frames per second, in a typical scenario. Then, the variable frame rate capture system 302 samples the second sequence of video frames at the abovementioned new video frame rate. In case of video game software, variable frame rates may be generated by considering past and/or forthcoming potential frame samples and with knowledge of motion vectors of graphic elements.

Finally, the video encoder 306 encodes the output of the variable frame rate capture system 304, time stamps them (to be able to determine the time separations between the video frames) and delivers them to be displayed on a screen or to be stored in a storage unit of the digital electronic video capturing system 302 (within memory of device 151).

For example, when the captured video content changes rapidly because of moving objects or rapid panning, a higher video frame rate sampling is employed (to minimize blurring) by the variable frame rate capture system 304. Similarly, when objects and scenes to be captured are relatively stationary, the frame rate is slowed down as it will be sufficient for the viewing eye. This difference in frame rates may involve linear or two or more lock-step changes. To carry out this approach in this embodiment, the digital electronic video capturing system is modified to generate frame sequences with time stamps associated with each frame so as to identify current frame separation. Hence, the variable frame rate capture system 304, in the first embodiment of current depiction, directly modifies the capture rate at the imager based on past frame comparison. The operations of the device 302 are described further herein with reference to the flow charts of FIGS. 4-8.

FIG. 3B is a block diagram illustrating components of a device constructed and operating according to one or more embodiments of the present invention for producing variable frame rate video output by parsing video frames of a fixed frame rate input. The variable frame rate video generation device 352 is incorporated into one or the devices 151 of FIG. 1. The variable frame rate video generation device 352 includes a video input 354, a variable frame rate video encoder 356, and processing circuitry 358. The video input 354 receives sequences of video frames, the variable frame rate video encoder 356 groups the video frames and selectively discards some video frames of sequential groups, depending upon the differences between the prior neighboring frames, and then encodes and time stamps the video frames to produce variable frame rate video stream. The operations of the variable frame rate video encoder 356 are performed in conjunction with the processing circuitry 358. In some operations, the video frame inspection and parsing is at least partially performed by the processing circuitry 358.

The variable frame rate video generation device 352 may work as an independent unit (as a stand-alone video capturing device) or may be incorporated into digital electronic video capturing systems (and electronic video games). The variable frame rate video generation device 352 takes input from an external source and generates a variable frame rate video stream that enhances the viewing video quality and in addition minimizes storage size of the visual media content hence generated. An off the shelf digital electronic video capturing system may consist of video capturing modules that sample the captured video content at a fixed frame rate. They generate a fixed frame rate video stream and it is preferable for the current embodiment that they generate at a much higher sampling rate, such as, instead of typical 24 to 30 frames per second, a sampling rate of 50 or 100 frames per second. The variable frame rate video generation device 352, while working in conjunction with these digital electronic video capturing systems (and electronic video games), generates video frames sampled at variable rates to produce a variable frame rate video stream.

Generally, the variable frame rate video encoder 352 receives a sequence of video frames at a first frame rate. A sequence may contain frames of few milliseconds to few seconds, for instance. Then, variable frame rate video encoder 356 and/or processing circuitry 358 determine quantitative differences between the neighboring video frames by comparing at least two neighboring video frames (at a fixed length of the received sequence of video frames). For instance, first and second video frames are compared, then, tenth and eleventh and so forth. Alternatively, the variable frame rate video encoder 356 and/or processing circuitry 358 may compare each of the video frames with the first video frame, within a sequence.

Once average numerical (quantitative) differences are determined, the variable frame rate video encoder 356 and/or processing circuitry partitions the sequence of video frames into a first sequential group of video frames and a second sequential group of video frames (alternatively, a plurality of groups, if a larger fixed length of the received sequence of video frames is considered). The partitioning is based upon the similarity between the frames within a group, such as, when the difference is minimal between few frames; they are taken as one group of frames.

Then, the variable frame rate video encoder 356 and/or processing circuitry 358 selectively discards some video frames of the first sequential group of video frames such that the first sequential group of video frames has a second frame rate that is less than the first frame rate. Similarly, the variable frame rate video encoder 356 and/or processing circuitry 358 may also selectively discard some video frames of the second (rest of the) sequential group(s) of video frames such that they have different frame rates of their own (that are less than the first frame rate). In the case of video game software, variable frame rates may be generated by considering past and/or forthcoming potential frame samples and with knowledge of motion vectors of graphic elements.

Finally, the variable frame rate video encoder 356 encodes the variable frame rate video content hence generated, time stamps them (to be able to determine the time separations between the video frames) and delivers them to be displayed on a screen or to be stored in a storage unit of the device 352.

FIG. 4 is a flow diagram illustrating functionality of a variable frame rate video generation device according to one or more embodiments of the present invention. The functionality of begins at a block 407 when the variable frame rate video generation device captures a first sequence of video frames at a first frame rate. The first frame rate may be within a range of typical capturing devices, that is, between 24 to 30 video frames per second or outside that range. Moreover, the sequence of video frames may be of few tens in numbers, for instance.

Next, at a block 409, the variable frame rate video generation device compares one or more of neighboring video frames to determine the differences. When the number of video frames in the first sequence of video frames is only few, the variable frame rate video generation device may compare only one set of two neighboring video frames (say, first and second of the first sequence of video frames). When the numbers of video frames within the first sequence of video frames is more, more comparisons may be made.

At a next block 411, the variable frame rate video generation device identifies a second frame rate for subsequent sequence video frames, based upon the differences at the block 409. At a next block 413, the variable frame rate video generation device captures a second (subsequent) sequence of video frames at the second frame rate.

At a final block 415, the variable frame rate video generation device encodes and time stamps the first and second captured sequences of video frames to produce the video stream.

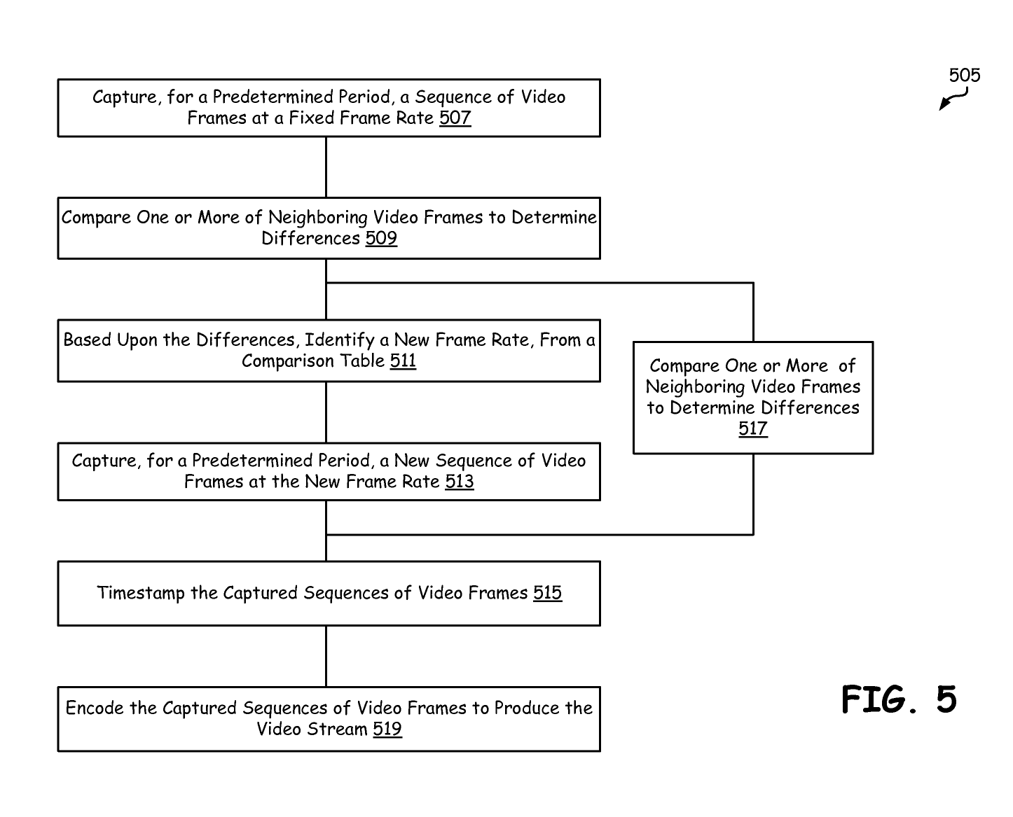

FIG. 5 is a flow diagram illustrating functionality of a variable frame rate video generation device according to one or more embodiments of the present invention. The functionality begins at a block 507 when the variable frame rate video generation device captures a sequence of video frames at a fixed frame rate, for a predetermined period. The predetermined period may be duration of ten video frames or multiples of tens, for instance. And, a fixed frame rate may be a standard one, centered between the typical slowest video frame rate and highest video frame rate chosen.

At a next block 509, the variable frame rate video generation device compares one or more of the neighboring video frames to determine the differences. The comparison may be done on pixel by pixel basis; for instance, in a matrix of two video frames; that is, a first pixel is compared with similarly positioned pixel of the neighboring video frame. Then, the differences are averaged out to determine a numerical value. Similar comparisons can be made between more video frames, when the sequence of video frames is long.

Based upon the differences, the variable frame rate video generation device, at a next block 511, identifies a new frame rate. This can be done, for instance, by using a look up table that provides different frame rates for different averaged out differences (having their own numerical values). At a next block 513, the variable frame rate video generation device captures, for a next predetermined period, a new sequence of video frames at the frame rate identified during the prior sequence. For instance, the averaged differences for a sequence of video frames, where there are barely any noticeable differences, are very low (and the frame rate can also be low). Similarly, for fast changing scenes, the averaged differences might be high (and the frame rate can also be high).

At a next block 517, again, the variable frame rate video generation device compares one or more of the neighboring video frames to determine the differences, within this new sequence of video frames of the block 513. The processes of the blocks 511, 513 and 517 continue as long as the variable frame rate video generation device is capturing video.

At a next block 515, the variable frame rate video generation device time stamps the captured sequences of video frames of the blocks 511, 513 and 517, to be able to identify the time separations between any two frames. At a final block 519, the variable frame rate video generation device encodes the captured and time stamped sequences of video frames to produce the video stream.

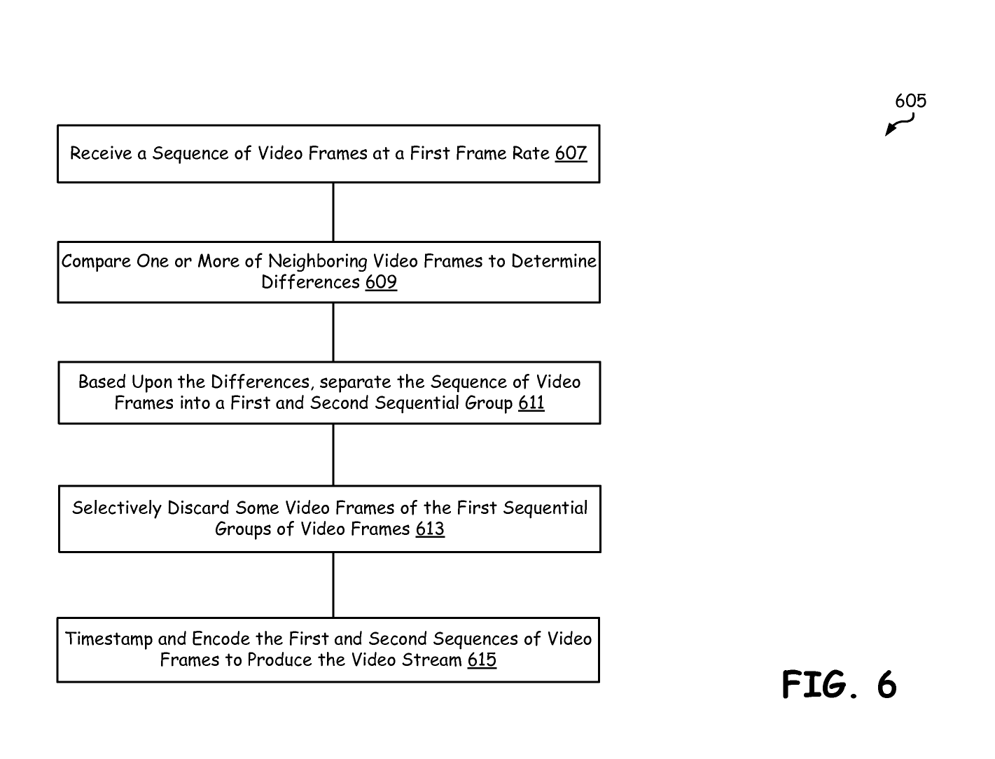

FIG. 6 is a flow diagram illustrating functionality of a variable frame rate video generation device according to one or more embodiments of the present invention. The functionality of begins at a block 607 when the variable frame rate video generation device receives a sequence of video frames at a first frame rate. As was the case with the embodiment of FIG. 4, the first frame rate may be within a typical value of between 24 to 30 video frames per second or outside that range. Moreover, the sequence of video frames may be of few tens in numbers, for instance.

At a next block 609, the variable frame rate video generation device compares one or more of neighboring video frames to determine the differences. The differences may be determined by comparing only one set of two neighboring video frames (say, first and second of the first sequence of video frames), when the number of video frames in the sequence of video frames is only few; otherwise, more comparisons may be made and the differences may be averaged out.

The variable frame rate video generation device groups the received sequence of video frames based upon the averaged out differences at the block 609, at a next block 611. The grouping is done in such a way that the video frames within a group consist of video frames with minimal differences. At a next block 613, the variable frame rate video generation device selectively discards some video frames from each of the groups to effectively alter the frame rates. At a final block 615, the variable frame rate video generation device encodes and time stamps the first and second received sequences of video frames to produce the video stream.

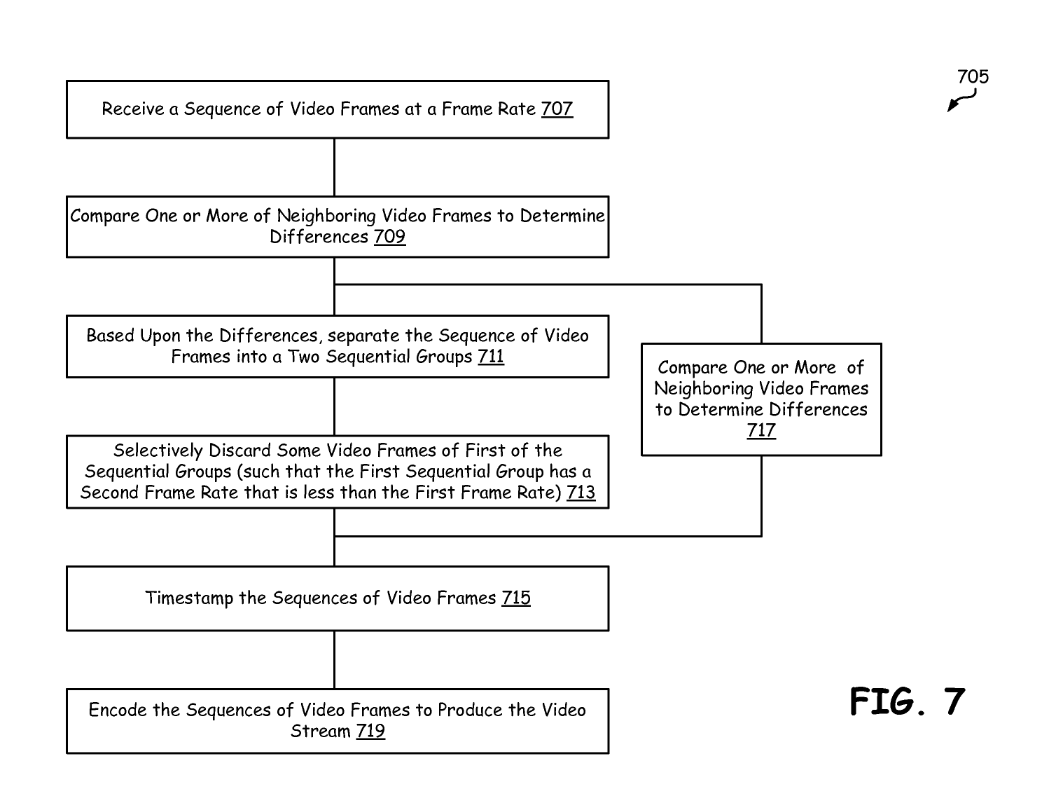

FIG. 7 is a flow diagram illustrating functionality of a variable frame rate video generation device according to one or more embodiments of the present invention. The functionality begins at a block 707 when the variable frame rate video generation device receives a sequence of video frames at a fixed frame rate, for a predetermined period. The predetermined period may be duration of ten video frames or multiples of tens, for instance. Moreover, the fixed frame rate may be a standard one, centered between the typical slowest video frame rate and highest video frame rate chosen.

At a next block 709, the variable frame rate video generation device compares one or more of the neighboring video frames to determine the differences. Pixel by pixel comparisons may be averaged to determine a numerical value. Similar comparisons can be made between more video frames, when the sequence of video frames is long.

Based upon the differences, the variable frame rate video generation device, at a next block 711, divides the sequence of video frames into two or more sequential groups that have very marginal or minimal differences. At a next block 713, the variable frame rate video generation device selectively discards some video frames from each of the groups to effectively alter the frame rates. At a next block 717, the variable frame rate video generation device compares one or more of the neighboring video frames to determine numerical values of the differences, within this new sequence of video frames of the block 713. The processes of the blocks 711, 713 and 717 continue as long as the variable frame rate video generation device is receiving sequences of video frames.

At a next block 715, the variable frame rate video generation device time stamps the received sequences of video frames of the blocks 711, 713 and 717, to be able to identify the time separations between any two frames. At a final block 719, the variable frame rate video generation device encodes the received and time stamped sequences of video frames to produce the video stream.

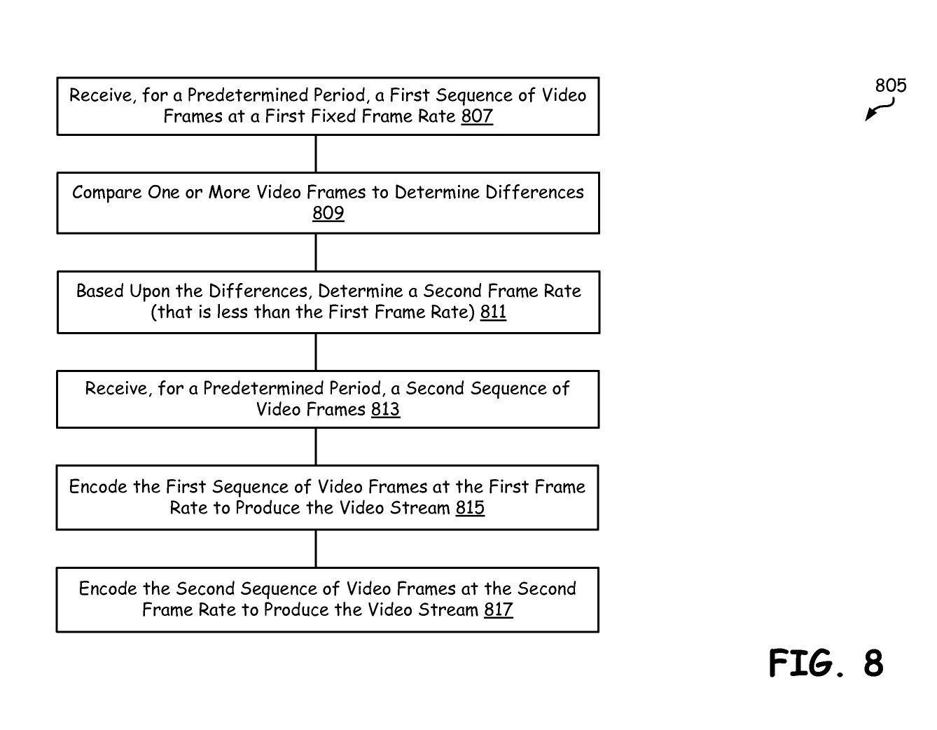

FIG. 8 is a flow diagram illustrating functionality of a variable frame rate video generation device according to one or more embodiments of the present invention. The functionality of begins at a block 807 when the variable frame rate video generation device receives a first sequence of video frames at a first frame rate. As is the case with the embodiment of the FIG. 4, the first frame rate may be within a range of typical video generation devices, that is, between 24 to 30 video frames per second or outside that range. Moreover, the sequence of video frames may be of few tens in numbers, for instance.

Next, at a block 809, the variable frame rate video generation device compares one or more of neighboring video frames to determine a numerical value for the differences henceforth determined. The variable frame rate video generation device may compare only one set of two neighboring video frames, when the number of video frames in the first sequence of video frames is only few; alternatively, many more comparisons may be made, when the numbers of video frames within the first sequence of video frames is high.

Based upon the differences at the block 809, at a next block 811, the variable frame rate video generation device identifies a second frame rate (that is less than the first frame rate) for subsequent sequence video frames. At a next block 813, the variable frame rate video generation device receives a second (subsequent) sequence of video frames.

At a next block 815, the variable frame rate video generation device encodes and time stamps the first received sequence at the first frame rate to produce the video stream. At a final block 817, the variable frame rate video generation device encodes and time stamps the second received sequence at the second frame rate to produce the video stream.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips Likewise, a first circuit and a second circuit may be combined in one embodiment into a single circuit or, in another embodiment, operate independently perhaps in separate chips. The term “chip”, as used herein, refers to an integrated circuit. Circuits and circuitry may comprise general or specific purpose hardware, or may comprise such hardware and associated software such as firmware or object code.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

1. A variable frame rate video generation device that generates an encoded video data stream comprising:
a variable frame rate capture system;
a video encoder;
the variable frame rate capture system captures a first sequence of video frames at a first frame rate;
the variable frame rate capture system compares at least two neighboring frames of the first sequence of video frames to determine differences between the at least two neighboring frames;
the variable frame rate capture system captures a second sequence of video frames at the first frame rate when a first comparison result is met;
the variable frame rate capture system captures a second sequence of video frames at a second frame rate that differs from the first frame rate when a second comparison result is met; and
the video encoder encodes the first sequence of video frames and the second sequence of video frames to produce the encoded video stream.

2. The variable frame rate video generation device of claim 1, wherein the variable frame rate capture system time stamps video frames of the first set of successive video frames and the second set of successive video frames.

3. The variable frame rate video generation device of claim 1, wherein:
the first sequence of video frames includes time stamps; and
the time stamps flow through encoding process.

4. The variable frame rate video generation device of claim 1, wherein:
the variable frame rate capture system captures a third sequence of video frames at a third frame rate that differs from both the first frame rate and the second frame rate when a third comparison result is met; and
the video encoder encodes the first sequence of video frames, the second sequence of video frames, and the third sequence of video frames to produce the encoded video stream.

5. The variable frame rate video generation device of claim 1, wherein the capturing is performed by digital camera.

6. The variable frame rate video generation device of claim 1, wherein:
the variable frame rate capture system is a portion of an electronic video game; and
comparing at least two neighboring frames of the first sequence of video frames to determine difference between the at least two neighboring frames is based upon graphical element content of the at least two neighboring frames.

7. A variable frame rate video generation device that generates a video stream for a later playback comprising:
a video input that receives a sequence of video frames at a first frame rate; and
a variable frame rate video encoder coupled to the video input, wherein:
the variable frame rate video encoder receives the sequence of video frames at the first frame rate from the video input;
the variable frame rate video encoder compares at least two neighboring frames of the sequence of video frames to determine differences between the at least two neighboring frames;
the variable frame rate video encoder partitions the sequence of video frames into a first sequential group of video frames and a second sequential group of video frames;
the variable frame rate video encoder selectively discards some video frames of the first sequential group of video frames such that the first sequential group of video frames has a second frame rate that is less than the first frame rate; and
the variable frame rate video encoder encodes the first sequential group of video frames and the second sequential group of video frames to produce the video stream.

8. The variable frame rate video generation device of claim 7, wherein the variable frame rate video encoder time stamps the video frames of the video stream.

9. The variable frame rate video generation device of claim 7, where the first sequential group of video frames has less relative inter-frame motion than does the second sequential group of video frames.

10. The variable frame rate video generation device of claim 7, wherein:
the variable frame rate video encoder partitions the second sequential group of video frames into a third sequential group of video frames and a fourth sequential group of video frames; and
the variable frame rate video encoder selectively discards some video frames of the third sequential group of video frames and the fourth sequential group of video frames such that the third sequential group of video frames and the fourth sequential group of video frames have differing frame rates.

11. A variable frame rate video generation device that generates an encoded video stream comprising:
a variable frame rate capture system;
a video encoder;
the variable frame rate capture system captures a first sequence of video frames at a first frame rate;
the variable frame rate capture system compares at least two neighboring frames of the first sequence of video frames to determine difference between the at least two neighboring frames;
the variable frame rate capture system captures a second sequence of video frames at a second frame rate that is greater than the first frame rate;
the variable frame rate capture system captures a third sequence of video frames at a third frame rate that is less than the first frame rate; and
the video encoder encodes the first sequence of video frames, the second sequence of video frames, and the third sequence of video frames to produce the encoded video stream.

12. The variable frame rate video generation device of claim 11, wherein the video encoder time stamps video frames of the first, second, and third sequence of video frames.

13. The variable frame rate video generation device of claim 11, wherein the variable frame rate capture system time stamps time stamps the video frames of the first, second, and third sequence of video frames.

14. The variable frame rate video generation device of claim 11, wherein the variable frame rate capture system steps a capture rate from the first capture rate to the second capture rate.

15. The variable frame rate video generation device of claim 11, wherein the variable frame rate capture system steps a capture rate from the first capture rate to the third capture rate.

16. The variable frame rate video generation device claim 11, wherein the variable frame rate capture system comprises a digital camera.

17. The variable frame rate video generation device of claim 11, wherein:
the variable frame rate capture system is a portion of an electronic video game; and
the variable frame rate capture system comparing at least two neighboring frames of the first sequence of video frames to determine difference between the at least two neighboring frames is based upon graphical element content of the at least two neighboring frames.

18. A method performed by a variable frame rate video generation device comprising:
capturing a first sequence of video frames at a first frame rate;
comparing at least one video frame of the first sequence of video frames to at least one neighboring video frame of the first sequence of video frames to determine differences between the compared video frames;
when a first comparison result is met, capturing a second sequence of video frames at a second frame rate that differs from the first frame rate;
when a second comparison result is met, capturing the second sequence of video frames at the first frame rate; and
encoding the first sequence of video frames and the second sequence of video frames to produce the video stream.

19. The method of claim 18, wherein comparing at least one video frame of the first sequence of video frames to at least one neighboring video frame of the first sequence of video frames to determine differences between the compared video frames comprises determining differences between compared frames.

20. The method of claim 18, wherein encoding the first sequence of video frames and the second sequence of video frames to produce the video stream comprises time stamping video frames of the first sequence of video frames and the second sequence of video frames.

21. The method of claim 18, wherein capturing a first sequence of video frames at a first frame rate comprises time stamping video frames of the first sequence of video frames.

22. The method of claim 18, wherein the second frame rate is less than the first frame rate.

23. The method of claim 18, wherein the third frame rate is greater than the first frame rate.

24. The method of claim 20, wherein the capturing is performed by a digital camera.

25. The method of claim 20, wherein:
the capturing is performed by a video game; and
comparing video frames includes comparing motion vectors of graphic elements of the video frames.

26. A method performed by a variable frame rate video generation device comprising:
receiving a sequence of video frames at a first frame rate;
comparing video frames of the sequence of video frames to neighboring video frames of the sequence of video frames to determine differences between compared video frames;
based upon the comparison:
separating the sequence of video frames into a first sequential group of video frames and a second sequential group of video frames; and
selectively discarding some video frames of the first sequential group of video frames such that the first sequential group of video frames has a second frame rate that is less than the first frame rate; and
encoding the first sequential group of video frames and the second sequential group of video frames to produce the video stream.

27. The method of claim 26, wherein comparing video frames comprises determining differences between the compared video frames.

28. The method of claim 26, wherein encoding the first sequential group of video frames and the second sequential group of video frames comprising time stamping video frames.

29. The method of claim 26, wherein:
the sequence of video frames at the first frame rate include time stamps; and
the time stamps flow through encoding remaining attached to encoded frames.

30. The method of claim 27, further comprising selectively discarding some video frames of the first sequential group of video frames to form a third sequential group of video frames having a third frame rate that is less than the first frame rate and that differs from the second frame rate.

31. A method performed by a variable frame rate video generation device comprising:
receiving a sequence of video frames at a first frame rate at an encoder;
the encoder comparing video frames of a sequence of video frames to neighboring video frames of the sequence of video frames to determine differences between compared video frames; and
the encoder, based upon the comparison:
encoding a first sequential group of video frames at the first frame rate; and
encoding a second sequential group of video frames at a second frame rate that is less than the first frame rate.

32. The method of claim 31, wherein comparing video frames comprises determining differences between the compared video frames.

33. The method of claim 31, wherein encoding the first sequential group of video frames and the second sequential group of video frames comprising time stamping video frames.

34. The method of claim 26, wherein:
the sequence of video frames at the first frame rate include time stamps; and
the time stamps flow through encoding remaining attached to encoded frames.
